(19) United States
(12) Patent Application Publication
(10) Pub. No.: US 2019/0229571 A1
(43) Pub. Date: Jul. 25, 2019

(54) ROTARY ELECTRIC MACHINE AND ROTOR THEREOF

(71) Applicant: HONDA MOTOR CO., LTD., Tokyo (JP)

(72) Inventor: Norifumi YASUDA, Wako-shi (JP)

(21) Appl. No.: 16/252,970

(22) Filed: Jan. 21, 2019

(30) Foreign Application Priority Data
Jan. 23, 2018 (JP) 2018-008986

(51) Int. Cl. H02K 1/32; H02K 1/27; H02K 21/14

(52) U.S. Cl. CPC H02K 1/32; H02K 21/14; H02K 1/276

(57) ABSTRACT

A rotary electric machine includes a cylindrical stator having a stator core on which stator coils are provided, and a rotor that is provided to be freely rotated in a hollow part of the stator and includes a rotor core supported on a rotating shaft and having a plurality of permanent magnets provided therein in a circumferential direction thereof, and a pair of end face plates provided at end parts in an axial direction of the rotor core, respectively. The rotor core has a refrigerant flow passage provided therein, the refrigerant flow passage passing through the rotor core in the axial direction. One end face plate of the pair of end face plates is provided with a refrigerant introducing section configured to introduce a refrigerant supplied via a refrigerant supply pipe into the refrigerant flow passage.

### CROSS-REFERENCE TO RELATED APPLICATION

This application is based upon and claims priority from the Japanese Patent Application No. 2018-008986, filed on Jan. 23, 2018, the entire contents of which are incorporated herein by reference.

### BACKGROUND OF THE INVENTION

### 1. Field of the Invention

The present invention relates to a rotary electric machine and a rotor thereof that are capable of suppressing a decrease in efficiency of the rotary electric machine.

### 2. Description of the Related Art

In recent years, vehicles have been widespread on which a rotary electric machine is mounted in addition to, or in place of an internal combustion engine as a driving source. Such vehicles are ones called hybrid vehicles or electric vehicles.

Such a rotary electric machine causes, in operation of the rotary electric machine, various losses including copper loss (loss due to electric resistance of stator coils), iron loss (loss due to magnetic characteristics of magnetic materials composing the stator core or the like), and mechanical loss (loss due to mechanical factors such as frictional or the like), thereby generating heat. Such heat generation of the rotary electric machine forms a factor that causes a decrease in efficiency of the rotary electric machine, such as causing demagnetization of permanent magnets provided in a rotor.

For the purpose of suppressing a decrease in efficiency of such a rotary electric machine, the applicant of the present application has previously proposed a rotor structure of a rotary electric machine intended for improvement in cooling efficiency (see Japanese Patent Application Publication No. 2017-184343 (Patent document 1)). The rotor structure of the rotary electric machine disclosed in Patent document 1 includes a rotary shaft, a rotor which is pivotally supported by the rotary shaft and provided with permanent magnets in a circumferential direction, and a refrigerant supply pipeline which supplies a refrigerant to the rotor in an axial direction of the rotor. In the rotor structure, the rotor has a hole which penetrates through the rotor in the axial direction and through which the refrigerant discharged from the refrigerant supply pipeline flows.

The rotor structure of the rotary electric machine disclosed in Patent document 1 enables improvement in cooling efficiency of the rotor of the rotary electric machine.

Generally, such a rotary electric machine causes a temperature rise of the rotor including permanent magnets as a rotational speed thereof becomes higher. When the temperature of the rotor rises, a decrease in efficiency of the rotary electric machine is caused. For this reason, there has been a strong demand for suppressing a decrease in efficiency of the rotary electric machine by suppressing a temperature rise of the rotor.

The present invention has therefore been made in view of the above problems, and an object of the present invention is to provide a rotary electric machine and a rotor thereof that are capable of suppressing a decrease in efficiency of the rotary electric machine.

### SUMMARY OF THE INVENTION

In order to attain the above object, according to an aspect of the present invention, a rotor of a rotary electric machine reflecting one aspect of the present invention includes: a rotor core supported on a rotating shaft and having a plurality of permanent magnets provided therein in a circumferential direction thereof; and a pair of end face plates provided at end parts in an axial direction of the rotor core, respectively, wherein the rotor core has at least one refrigerant flow passage provided therein, the refrigerant flow passage passing through the rotor core in the axial direction, and one end face plate of the pair of end face plates is provided with at least one refrigerant introducing section configured to introduce a refrigerant supplied into the at least one refrigerant flow passage.

Moreover, a rotary electric machine reflecting another aspect of the present invention includes: a cylindrical stator having a stator core on which a coil is provided; and a rotor that is provided to be freely rotated in a hollow part of the stator and includes:

a rotor core supported on a rotating shaft and having a plurality of permanent magnets provided therein in a circumferential direction thereof; and a pair of end face plates provided at end parts in an axial direction of the rotor core, respectively, wherein the rotor core has a refrigerant flow passage provided therein, the refrigerant flow passage passing through the rotor core in the axial direction, and one end face plate of the pair of end face plates is provided with a refrigerant introducing section configured to introduce a refrigerant supplied via a refrigerant supply pipe into the refrigerant flow passage.

### BRIEF DESCRIPTION OF THE DRAWINGS

The features and advantages provided by one or more embodiments of the invention will become apparent from the detailed description given below and appended drawings which are given only by way of illustration, and thus are not intended as a definition of the limits of the present invention.

FIG. 1A is a longitudinal section view showing the entire configuration of a rotary electric machine according to an embodiment of the present invention.

FIG. 1B is an enlarged view of the periphery of a rotor of the rotary electric machine shown in FIG. 1A.

FIG. 2 is a front view of a rotor core provided in the rotor of the rotary electric machine according to the embodiment of the present invention.

FIG. 3A is a front view of an end face plate having a refrigerant introducing section, of a pair of end face plates provided in the rotor of the rotary electric machine according to the embodiment of the present invention.

FIG. 3B is a perspective view conceptually illustrating the refrigerant introducing section provided on the end face plate shown in FIG. 3A.

FIG. 4A is a front view of an end face plate having a refrigerant discharging section, of the pair of end face plates provided in the rotor of the rotary electric machine according to the embodiment of the present invention.

FIG. 4B is a perspective view conceptually illustrating the refrigerant discharging section provided on the end face plate shown in FIG. 4A.

### DETAILED DESCRIPTION OF THE PREFERRED EMBODIMENTS

Hereinafter, a rotary electric machine and a rotor thereof according to one or more embodiments of the present invention will be described in detail with reference to the drawings as necessary.

Note that in the drawings, the same members or corresponding members are given the same reference signs. Moreover, sizes and shapes of the members are schematically illustrated in a modified or exaggerated manner in some cases, for convenience of explanation.

### <Configuration of a Rotary Electric Machuine 11 According to tan Embodiment of the Present Invention>

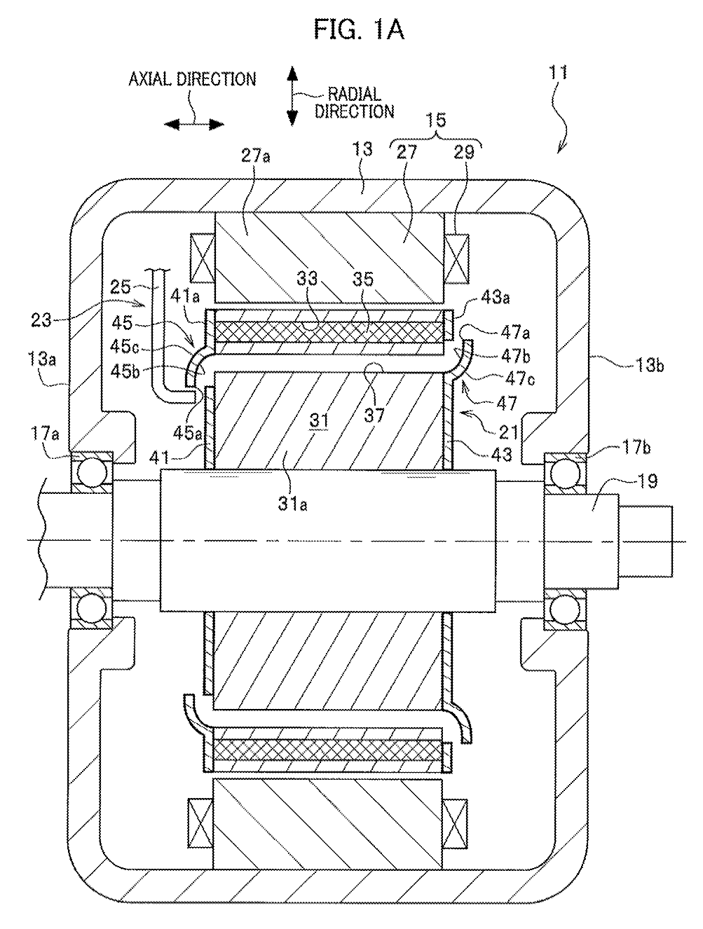

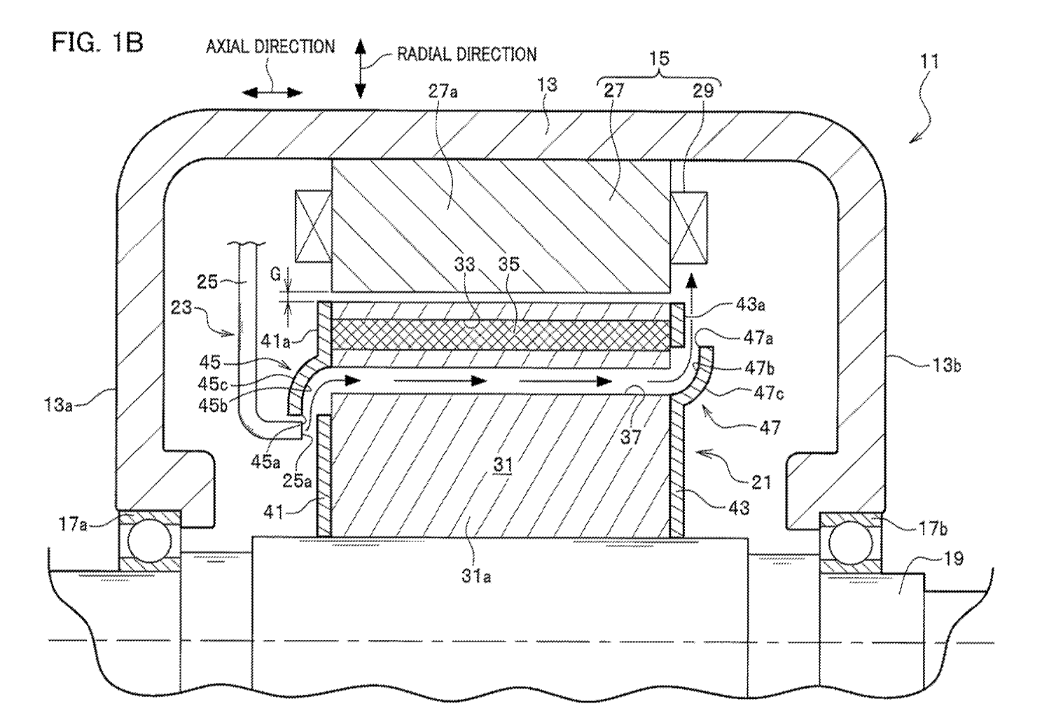

First, the rotary electric machine 11 according to the embodiment of the present invention will be described in detail with reference to FIGS. 1A and 1B.

FIG. 1A is a longitudinal section view showing the entire configuration of the rotary electric machine 11 according to the embodiment of the present invention. FIG. 1B is an enlarged view of the periphery of a rotor 21 of the rotary electric machine 11 shown in FIG. 1A.

As shown in FIG. 1A and FIG. 1B, the rotary electric machine 11 according to the embodiment of the present invention is composed of: a stator 15 provided on a cylindrical housing 13; a rotating shaft 19 supported by a pair of bearings 17a, 17b that are provided in side walls 13a, 13b of the housing 13, respectively; a rotor 21 provided on the rotating shaft 19; and a refrigerant supply device 23.

The stator 15 is provided on the housing 13 by attaching a cylindrical outer circumferential surface thereof to an inner circumferential surface of the cylindrical housing 13. The stator 15 is composed of a stator core 27 and stator coils 29 provided on the stator core 27.

As shown in FIG. 1A and FIG. 1B, the stator core 27 is formed into a cylindrical shape as a whole. The stator core 27 is configured, for example, by laminating a plurality of electromagnetic steel sheets 27a each formed into an annular shape, in an axial direction. The stator coils 29 are each provided in each of a plurality of slots (not shown) provided on the stator core 27.

In the rotary electric machine 11, when a motor current is supplied to the stator coils 29, a rotating magnetic field is generated in the stator 15. The rotating magnetic field generated in the stator 15 in this way and magnetic fields generated by permanent magnets 35 to be described later provided in the rotor 21 interact with each other, thereby allowing the rotor 21 to be driven to rotate.

### <Configuration of the Rotor 21 of the Rotary Electric Machine 11 According to the Embodiment of the Present Invention>

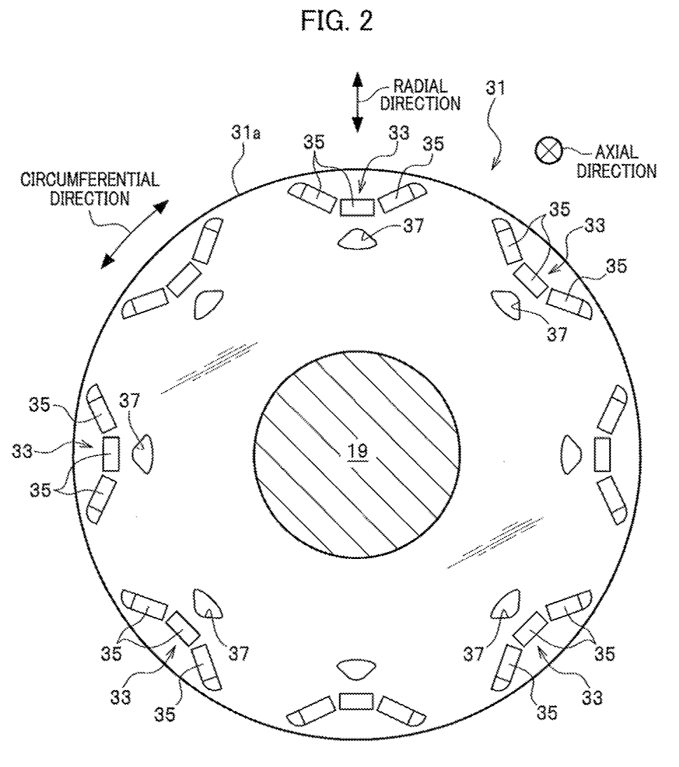

Next, configuration of the rotor 21 of the rotary electric machine 11 according to the embodiment of the present invention will be described with reference to FIGS. 2, 3A, 3B, 4A and 4B.

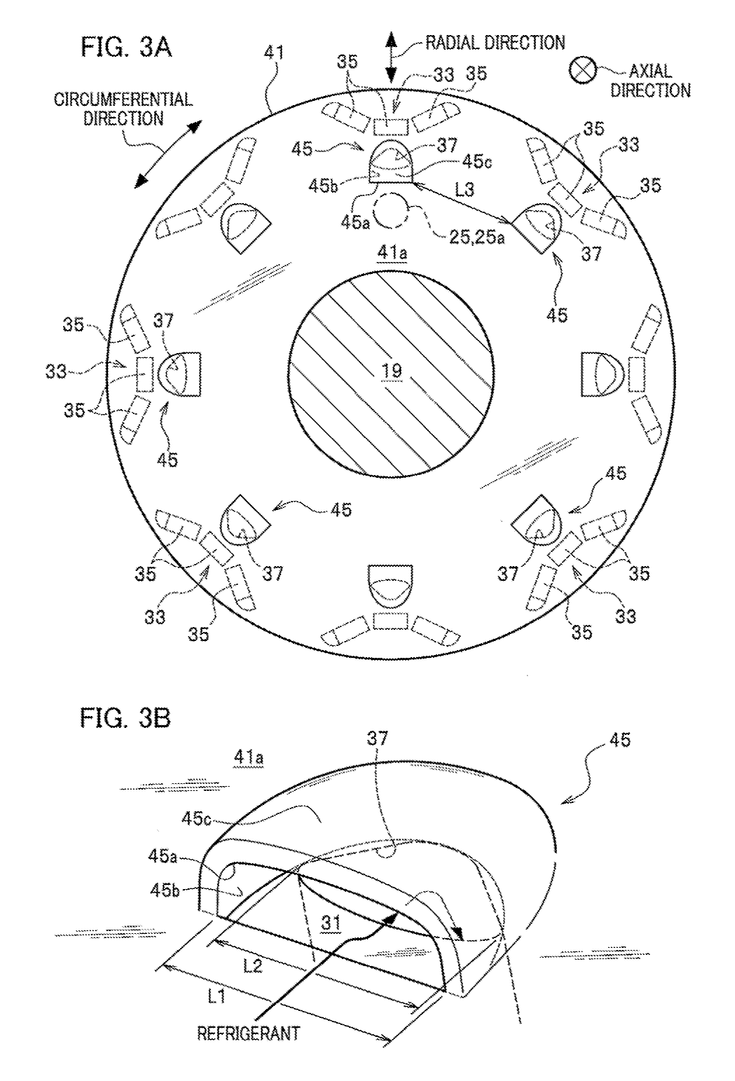

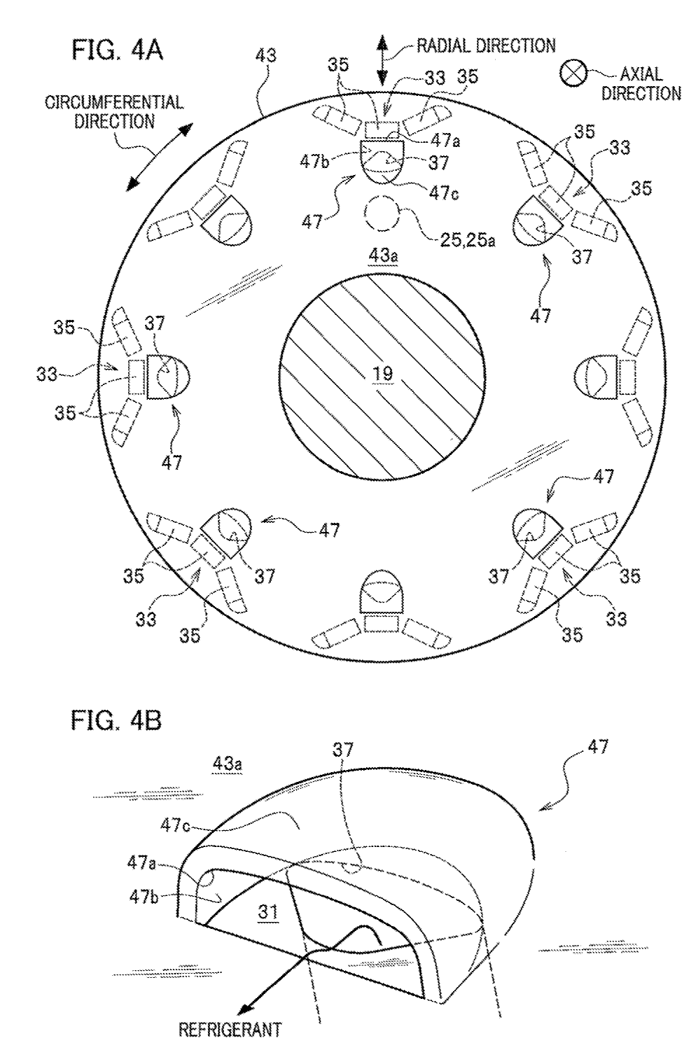

FIG. 2 is a front view of a rotor core 31 provided in the rotor 21 of the rotary electric machine 11 according to the embodiment of the present invention. FIG. 3A is a front view of an end face plate having a refrigerant introducing section 45, of a pair of end face plates provided in the rotor 21 of the rotary electric machine 11. FIG. 3B is a perspective view conceptually illustrating the refrigerant introducing section 45 provided on the end face plate shown in FIG. 3A. FIG. 4A is a front view of an end face plate having a refrigerant discharging section 47, of the pair of end face plates provided in the rotor 21 of the rotary electric machine 11. FIG. 4B is a perspective view conceptually illustrating the refrigerant discharging section 47 provided on the end face plate shown in FIG. 4A.

As shown in FIG. 1A and FIG. 1B, the rotor 21 of the rotary electric machine 11 according to the embodiment of the present invention is provided so as to be freely rotated via a slight gap G (see FIG. 1B) in a hollow part on the inner circumferential side of the stator 15. The rotor 21 includes the rotor core 31, and a pair of end face plates (a first end face plate 41 and a second end face plate 43).

As shown in FIG. 1A and FIG. 1B, the rotor core 31 is formed into a cylindrical shape as a whole. The rotor core 31 is configured, for example, by laminating a plurality of electromagnetic steel sheets 31a each formed into an annular shape as shown in FIG. 2, in an axial direction.

As shown in FIG. 1A, FIG. 1B and FIG. 2, the rotor core 31 has a plurality of sets of magnet insertion holes 33 passing through the rotor core 31 in the axial direction (see FIG. 1A and FIG. 1B) and provided at equal intervals in the circumferential direction (see FIG. 2) of the rotor core 31. A transverse section of one set of magnet insertion holes 33 is formed, although not particularly limited, into a nearly V shape that widens outward in the radial direction (see FIG. 2) of the rotor core 31.

The one set of magnet insertion holes 33 is composed of three holes combined together. As shown in FIG. 1A, FIG. 1B and FIG. 2, bar-shaped permanent magnets 35 are inserted into the one set of magnet insertion holes 33 and fixed by filling material (not shown) . A length of the permanent magnet 35 is set to be the same length as the entire length in the axial direction (see FIG. 1A and FIG. 1B) of the rotor core 31.

Moreover, as shown in FIG. 1A, FIG. 1B and FIG. 2, the rotor core 31 has a plurality of refrigerant flow passages 37 passing through the rotor core 31 in the axial direction (see FIG. 1A and FIG. 1B) and provided at equal intervals in the circumferential direction (see FIG. 2) of the rotor core 31. The number of refrigerant flow passages 37 is the same as the number of sets of magnet insertion holes 33. The refrigerant flow passage 37 is provided to be close to the one set of magnet insertion holes 33 (permanent magnets 35) on the inner side in the radial direction (see FIG. 2) of the rotor core 31 seen from the magnet insertion holes 33.

A transverse section of the refrigerant flow passage 37 is formed into a nearly triangular shape one apex of which is directed toward the outer side in the radial direction (see FIG. 2) of the rotor core 31. Three apices involved in the transverse section of the refrigerant flow passage 37 are chamfered.

The first end face plate 41 and the second end face plate 43 each formed into an annular shape are provided, as a pair of end face plates, at end parts in the axial direction (see FIG. 1A and FIG. 1B) of the rotor core 31, respectively. The first end face plate 41 and the second end face plate 43 are formed of non-magnetic metallic material, e.g., non-magnetic stainless steel (SUS305), aluminum or the like.

As shown in FIG. 1A, FIG. 1B and FIG. 3A, the first end face plate 41 is provided with the refrigerant introducing section 45 that is configured to introduce a refrigerant (for example, insulating oil or the like) supplied via a refrigerant supply pipe 25 of the refrigerant supply device 23 into the refrigerant flow passage 37.

Herein, the refrigerant supply device 23 will be described. As shown in FIG. 1A and FIG. 1B, the refrigerant supply device 23 is composed of a refrigerant discharging part (not shown) configured to discharge a refrigerant sent by a pump (not shown), and the refrigerant supply pipe 25. The refrigerant discharging part is adapted to discharge the refrigerant supplied via the refrigerant supply pipe 25 to the axial direction (see FIG. 1B) of the rotor core 31.

As shown in FIG. 1B and FIG. 3B, the refrigerant introducing section 45 is formed to protrude from a base plane 41a of the first end face plate 41. As shown in FIG. 3A and FIG. 3B, the refrigerant introducing section 45 includes an inlet 45a through which the refrigerant supplied via the refrigerant supply pipe 25 is introduced, and a guiding part 45b that is configured to guide the refrigerant introduced through the inlet 45a to the refrigerant flow passage 37.

The refrigerant introducing section 45 can be formed, although not particularly limited, for example, by performing punch press working on necessary positions in the circumferential direction of an annularly-formed non-magnetic metallic material which is to form the first end face plate 41.

As shown in FIGS. 1A, 1B, 3A and 3B, the inlet 45a of the refrigerant introducing section 45 protrudes from the base plane 41a (see FIG. 3B) of the first end face plate 41, and opens toward the inner side in the radial direction (see FIG. 1B) of the rotor core 31 seen from the refrigerant introducing section 45, i.e., toward a refrigerant discharge opening 25a of the refrigerant supply pipe 25 disposed on the rotating shaft 19 side.

As shown in FIG. 3B, a dimension L1 in the circumferential direction of the inlet 45a of the refrigerant introducing section 45 is set to be equal to or greater than a dimension L2 in the circumferential direction of the refrigerant flow passage 37. This makes it possible to facilitate the flow of the refrigerant which is to be guided through the inlet 45a of the refrigerant introducing section 45 to the refrigerant flow passage 37.

Note that when the dimension L1 in the circumferential direction of the inlet 45a is variably adjusted, a distance L3 (see FIG. 3A) between adjacent refrigerant introducing sections 45 is also changed.

This means that variable adjustment of the dimension L1 in the circumferential direction of the inlet 45a makes it possible to suitably adjust a distribution ratio of a refrigerant that is not introduced into the refrigerant flow passage 37 but acts so as to cool a peripheral region of the first end face plate 41, to a refrigerant that is introduced into the refrigerant flow passage 37 and acts so as to cool the rotor core 31 including the permanent magnets 35.

As shown in FIGS. 1A, 1B, 3A and 3B, the guiding part 45b of the refrigerant introducing section 45 is formed as a closed space lying inside a protruded outer wall part 45c that protrudes from the base plane 41a (see FIG. 1B and FIG. 3B) of the first end face plate 41. The guiding part 45b of the refrigerant introducing section 45 has a function of bending a flow direction of the refrigerant introduced through the inlet 45a, at a nearly right angle from the radial direction to the axial direction (see FIG. 1B) of the rotor core 31, thereby guiding the refrigerant to the refrigerant flow passage 37.

On the other hand, as shown in FIG. 1A, FIG. 1B and FIG. 4A, the second end face plate 43 is provided with the refrigerant discharging section 47 that is configured to discharge the refrigerant having passed through the refrigerant flow passage 37, to the outside of the rotor core 31. As shown in FIG. 1B and FIG. 4B, the refrigerant discharging section 47 is formed to protrude from a base plane 43a of the second end face plate 43 in the same manner as the refrigerant introducing section 45.

As shown in FIG. 4A and FIG. 4B, the refrigerant discharging section 47 includes an outlet 47a through which the refrigerant having passed through the refrigerant flow passage 37 is discharged to the outside of the rotor core 31, and a guiding part 47b that is configured to guide the refrigerant having passed through the refrigerant flow passage 37 to the outlet 47a.

As shown in FIGS. 1A, 1B, 4A and 4B, the guiding part 47b of the refrigerant discharging section 47 is formed as a closed space lying inside a protruded outer wall part 47c that protrudes from the base plane 43a (see FIG. 4B) of the second end face plate 43. The guiding part 47b of the refrigerant discharging section 47 has a function of bending a flow direction of the refrigerant having passed through the refrigerant flow passage 37, at a nearly right angle from the axial direction to the radial direction (see FIG. 1B) of the rotor core 31, thereby guiding the refrigerant to the outlet 47a.

As shown in FIGS. 1A, 1B, 4A and 4B, the outlet 47a of the refrigerant discharging section 47 protrudes from the base plane 43a (see FIG. 1B and FIG. 4B) of the second end face plate 43, and opens toward the outer side in the radial direction (see FIG. 1B) of the rotor core 31 seen from the refrigerant discharging section 47, i.e., toward a crossover part lying on end parts of the stator coils 29. Note that the crossover part is a part at which in-phase stator coils 29 are connected to each other.

### <Action of the Rotor 21 of the Rotary Electric Machine 11 According to the Embodiment of the Present Invention>

Next, description will be given of action of the rotor 21 of the rotary electric machine 11 according to the embodiment of the present invention.

When a motor current is supplied to the stator coils 29, a rotating magnetic field is generated in the stator 15. The rotating magnetic field generated in the stator 15 in this way and magnetic fields generated by the permanent magnets 35 provided in the rotor 21 interact with each other, thereby allowing the rotor 21 to be driven to rotate.

In operation of the rotary electric machine 11, various losses impairing efficiency of the rotary electric machine 11 generate heat to cause a temperature of the rotary electric machine 11 to rise. In particular, a temperature rise of the permanent magnets 35 provided in the rotor 21 forms a factor that decreases a magnetic force of the permanent magnets 35 to cause a decrease in efficiency of the rotary electric machine 11. For this reason, it is of importance that the rotor 21 including the permanent magnets 35 is efficiently cooled to suppress a temperature rise of the rotor 21.

In this respect, the rotor 21 of the rotary electric machine 11 based on a first aspect of the present invention allows the rotor core 31 to have at least one refrigerant flow passage 37 provided therein, the refrigerant flow passage 37 passing through the rotor core 31 in the axial direction, and allows one end face plate (first end face plate 41) of the pair of end face plates to be provided with at least one refrigerant introducing section 45 configured to introduce a refrigerant supplied into the at least one refrigerant flow passage 37, thus making it possible to improve cooling efficiency of the rotor core 31. Consequently, a decrease in efficiency of the rotary electric machine 11 can be suppressed.

Furthermore, the rotor 21 of the rotary electric machine 11 based on the first aspect of the present invention allows the refrigerant to be introduced (see the refrigerant flow indicated by arrow marks in FIG. 1B) via the refrigerant introducing section 45 provided on one end face plate (first end face plate 41) of the pair of end face plates into the refrigerant flow passage 37, thus making it possible to suppress a decrease in efficiency of the rotary electric machine 11 while preventing stress concentration on apart of the rotating shaft (a place corresponding to the refrigerant flow passage on the rotating shaft) with a relatively simple structure (no refrigerant flow passage is provided in the rotating shaft), as compared to conventional cooling technology which applies a refrigerant onto side surfaces of the end face plates via refrigerant flow passages provided in the rotating shaft (for example, Japanese Patent Application Publication No. 09-182375).

Moreover, the rotor 21 of the rotary electric machine 11 based on a second aspect of the present invention allows the at least one refrigerant flow passage to have a plurality of refrigerant flow passages 37 provided at equal intervals in the circumferential direction of the rotor core 31, and allows the at least one refrigerant introducing section to have a plurality of refrigerant introducing sections 45 provided for the plurality of refrigerant flow passages 37, thus making it possible to equalize a temperature of the rotor core 31 to a relatively low temperature to enhance the cooling efficiency of the rotor core 31, as compared to the rotor 21 of the rotary electric machine 11 based on the first aspect. Consequently, demagnetization of the permanent magnets 35 can be suppressed and thus a decrease in efficiency of the rotary electric machine 11 can be suppressed.

Moreover, the rotor 21 of the rotary electric machine 11 based on a third aspect of the present invention allows the plurality of refrigerant flow passages 37 to be provided to be close to the plurality of permanent magnets 35, thus making it possible to equalize temperatures of the plurality of permanent magnets 35 to a relatively low temperature to enhance the cooling efficiency of the rotor core 31, as compared to the rotor 21 of the rotary electric machine 11 based on the first and second aspects. Consequently, demagnetization of the permanent magnets 35 can be suppressed and thus a decrease in efficiency of the rotary electric machine 11 can be suppressed.

Moreover, the rotor 21 of the rotary electric machine 11 based on a fourth aspect of the present invention allows the refrigerant introducing section 45 to have the inlet 45a through which the refrigerant supplied to the refrigerant introducing section 45 from the side of the rotating shaft 19 is introduced, and allows the inlet 45a to open toward the side of the rotating shaft 19, thus allowing centrifugal force to act on the refrigerant introduced through the inlet 45a in operation of the rotary electric machine 11.

This causes guidance to the refrigerant flow passage 37 of the refrigerant introduced through the inlet 45a to be promoted in operation of the rotary electric machine 11. As a result, the refrigerant introduced through the inlet 45a never stagnates. That is, since a new refrigerant is constantly supplied to the refrigerant flow passage 37, the cooling efficiency of the rotor core 31 can be enhanced.

Moreover, with an increase in the rotational speed of the rotary electric machine 11, the centrifugal force that acts on the refrigerant introduced through the inlet 45a also becomes great. That is, refrigerant guidance promoting effect due to the centrifugal force becomes increased as the rotational speed of the rotary electric machine 11 becomes higher.

Accordingly, the rotor 21 of the rotary electric machine 11 based on the fourth aspect of the present invention also makes it possible to expect effect of variably setting cooling efficiency of the rotor 21 in response to the rotational speed of the rotary electric machine 11.

Moreover, the rotor 21 of the rotary electric machine 11 based on a fifth aspect of the present invention allows another end face plate (second end face plate 43) of the pair of end face plates to be provided with the refrigerant discharging section 47 configured to discharge the refrigerant having passed through the refrigerant flow passage 37, to the outside of the rotor core 31, thus making it possible to enhance the cooling efficiency of the rotor core 31 by quickly discharging the refrigerant to promote the flow of refrigerant in the refrigerant flow passage 37. Consequently, a decrease in efficiency of the rotary electric machine 11 can be suppressed.

Moreover, the rotor 21 of the rotary electric machine 11 based on a sixth aspect of the present invention allows the refrigerant discharging section 47 to have the outlet 47a through which the refrigerant having passed through the refrigerant flow passage 37 is discharged, and allows the outlet 47a to open toward an opposite side to the side of the rotating shaft 19, thus making it possible to effectively cool a part in the vicinity of the refrigerant discharging section 47 and near the opposite side to the side of the rotating shaft 19, on the second end face plate 43. Consequently, a decrease in efficiency of the rotary electric machine 11 can be suppressed.

On the other hand, the rotary electric machine 11 based on a seventh aspect of the present invention allows the rotor core 31 to have the refrigerant flow passage 37 provided therein, the refrigerant flow passage 37 passing through the rotor core 31 in the axial direction, and allows one end face plate (first end face plate 41) of the pair of end face plates to be provided with the refrigerant introducing section 45 configured to introduce a refrigerant supplied via the refrigerant supply pipe 25 into the refrigerant flow passage 37, thus making it possible to improve cooling efficiency of the rotor core 31. Consequently, the rotary electric machine 11 capable of suppressing demagnetization of the permanent magnets 35 and having excellent efficiency can be obtained.

Moreover, the rotary electric machine 11 based on an eighth aspect of the present invention allows another end faceplate (second end face plate 43) of the pair of end face plates to be provided with the refrigerant discharging section 47 configured to discharge the refrigerant having passed through the refrigerant flow passage 37, to the outside of the rotor core 31, thus making it possible to enhance the cooling efficiency of the rotor core 31 by quickly discharging the refrigerant to promote the flow of refrigerant in the refrigerant flow passage 37. Consequently, the rotary electric machine 11 having excellent efficiency can be obtained.

Moreover, the rotary electric machine 11 based on a ninth aspect of the present invention allows the refrigerant discharging section 47 to have the outlet 47a through which the refrigerant having passed through the refrigerant flow passage 37 is discharged, and allows the outlet 47a to open toward the end parts of the stator coils 29 provided on the stator core 27, thus making it possible to effectively cool the vicinity of the crossover part lying on the end parts of the stator coils 29. Consequently, the rotary electric machine 11 having excellent efficiency can be obtained.

### <Other Embodiments>

The embodiments described above only show examples of materialization of the present invention. Therefore, the technical scope of the present invention should not be restrictively interpreted by the embodiments, because the present invention can be put into effect in various forms without departing from the gist or essential features thereof.

Although the above embodiment of the present invention has been described, by way of example, taking the case in which the dimension L1 in the circumferential direction of the inlet 45a is variably adjusted, thereby variably adjusting the distribution ratio of a refrigerant that is not introduced into the refrigerant flow passage 37 but acts so as to cool the peripheral region of the first end face plate 41, to a refrigerant that is introduced into the refrigerant flow passage 37 and acts so as to cool the rotor core 31 including the permanent magnets 35, the present invention is not limited to this example.

An embodiment may be adopted such that flow resistance of a refrigerant associated with the refrigerant introducing section 45 and flow resistance of a refrigerant associated with the refrigerant discharging section 47 are variably adjusted, thereby variably adjusting the distribution ratio of a refrigerant that is not introduced into the refrigerant flow passage 37 but acts so as to cool the peripheral region of the first end face plate 41, to a refrigerant that is introduced into the refrigerant flow passage 37 and acts so as to cool the rotor core 31 including the permanent magnets 35.

Moreover, although the above embodiment of the present invention has been described, by way of example, taking the case in which eight sets of magnet insertion holes 33 and permanent magnets 35, eight refrigerant flow passages 37, eight refrigerant introducing sections 45, and eight refrigerant discharging sections 47 are provided at equal intervals in the circumferential direction of the rotor core 31, the present invention is not limited to this example. The number of sets of magnet insertion holes 33 and permanent magnets 35, the number of refrigerant flow passages 37, the number of refrigerant introducing sections 45, and the number of refrigerant discharging sections 47 may be set to an arbitrary number including eight.

Furthermore, although the above embodiment of the present invention has been described, by way of example, taking the case in which the refrigerant discharging section 47 is formed to protrude from the base plane 43a of the second end face plate 43, the present invention is not limited to this example. An embodiment may be adopted such that a discharge groove for refrigerant extending in the radial direction is carved on the inside surface of the second end face plate 43, thereby forming the refrigerant discharging section 47 on the second end face plate 43.

Although the embodiments of the present invention have been described and illustrated in detail, the disclosed embodiments are made for purposes of illustration and example only and not limitation. The scope of the present invention should be interpreted by terms of the appended claims.

### DESCRIPTION OF REFERENCE SIGNS.

11: Rotary electric machine; 15: Stator; 19: rotating shaft; 21: Rotor; 25: Refrigerant supply pipe; 27: Stator core; 29: Stator coil (Coil); 31: Rotor core; 35: Permanent magnet; 37: Refrigerant flow passage; 41: First end face plate (One end face plate of a pair of end face plates); 43: Second end face plate (Another end face plate of the pair of end face plates) ; 45: Refrigerant introducing section; 45a: Inlet; 47: Refrigerant discharging section; 47a: Outlet

What is claimed is:

1. A rotor of a rotary electric machine, comprising:
a rotor core supported on a rotating shaft and having a plurality of permanent magnets provided therein in a circumferential direction thereof; and
a pair of end face plates provided at end parts in an axial direction of the rotor core, respectively, wherein
the rotor core has at least one refrigerant flow passage provided therein, the refrigerant flow passage passing through the rotor core in the axial direction, and
one end face plate of the pair of end face plates is provided with at least one refrigerant introducing section configured to introduce a refrigerant supplied into the at least one refrigerant flow passage.

2. The rotor of the rotary electric machine, as set forth in claim 1, wherein
the at least one refrigerant flow passage has a plurality of refrigerant flow passages provided at equal intervals in the circumferential direction of the rotor core, and
the at least one refrigerant introducing section has a plurality of refrigerant introducing sections provided for the plurality of refrigerant flow passages.

3. The rotor of the rotary electric machine, as set forth in claim 2, wherein
the plurality of refrigerant flow passages are provided to be close to the plurality of permanent magnets.

4. The rotor of the rotary electric machine, as set forth in claim 1, wherein
the refrigerant introducing section has an inlet through which the refrigerant supplied is introduced, and
the inlet opens toward a side of the rotating shaft.

5. The rotor of the rotary electric machine, as set forth in claim 2, wherein
the refrigerant introducing section has an inlet through which the refrigerant supplied is introduced, and
the inlet opens toward a side of the rotating shaft.

6. The rotor of the rotary electric machine, as set forth in claim 3, wherein
the refrigerant introducing section has an inlet through which the refrigerant supplied is introduced, and
the inlet opens toward a side of the rotating shaft.

7. The rotor of the rotary electric machine, as set forth in claim 1, wherein
another end face plate of the pair of end face plates is provided with a refrigerant discharging section configured to discharge the refrigerant having passed through the refrigerant flow passage, to an outside of the rotor core.

8. The rotor of the rotary electric machine, as set forth in claim 7, wherein
the refrigerant discharging section has an outlet through which the refrigerant having passed through the refrigerant flow passage is discharged, and
the outlet opens toward an opposite side to a side of the rotating shaft.

9. The rotor of the rotary electric machine, as set forth in claim 2, wherein
another end face plate of the pair of end face plates is provided with a refrigerant discharging section configured to discharge the refrigerant having passed through the refrigerant flow passage, to an outside of the rotor core.

10. The rotor of the rotary electric machine, as set forth in claim 9, wherein
the refrigerant discharging section has an outlet through which the refrigerant having passed through the refrigerant flow passage is discharged, and
the outlet opens toward an opposite side to a side of the rotating shaft.

11. The rotor of the rotary electric machine, as set forth in claim 3, wherein
another end face plate of the pair of end face plates is provided with a refrigerant discharging section configured to discharge the refrigerant having passed through the refrigerant flow passage, to an outside of the rotor core.

12. The rotor of the rotary electric machine, as set forth in claim 11, wherein
the refrigerant discharging section has an outlet through which the refrigerant having passed through the refrigerant flow passage is discharged, and
the outlet opens toward an opposite side to a side of the rotating shaft.

13. The rotor of the rotary electric machine, as set forth in claim 4, wherein
another end face plate of the pair of end face plates is provided with a refrigerant discharging section configured to discharge the refrigerant having passed through the refrigerant flow passage, to an outside of the rotor core.

14. The rotor of the rotary electric machine, as set forth in claim 13, wherein
the refrigerant discharging section has an outlet through which the refrigerant having passed through the refrigerant flow passage is discharged, and
the outlet opens toward an opposite side to a side of the rotating shaft.

15. The rotor of the rotary electric machine, as set forth in claim 5, wherein
another end face plate of the pair of end face plates is provided with a refrigerant discharging section configured to discharge the refrigerant having passed through the refrigerant flow passage, to an outside of the rotor core.

16. The rotor of the rotary electric machine, as set forth in claim 15, wherein
the refrigerant discharging section has an outlet through which the refrigerant having passed through the refrigerant flow passage is discharged, and
the outlet opens toward an opposite side to a side of the rotating shaft.

17. A rotary electric machine comprising:
a cylindrical stator having a stator core on which a coil is provided; and
a rotor that is provided to be freely rotated in a hollow part of the stator and includes: a rotor core supported on a rotating shaft and having a plurality of permanent magnets provided therein in a circumferential direction thereof; and a pair of end face plates provided at end parts in an axial direction of the rotor core, respectively, wherein
the rotor core has a refrigerant flow passage provided therein, the refrigerant flow passage passing through the rotor core in the axial direction, and
one end face plate of the pair of end face plates is provided with a refrigerant introducing section configured to introduce a refrigerant supplied via a refrigerant supply pipe into the refrigerant flow passage.

18. The rotary electric machine as set forth in claim 17, wherein
another end face plate of the pair of end face plates is provided with a refrigerant discharging section configured to discharge the refrigerant having passed through the refrigerant flow passage, to an outside of the rotor core.

19. The rotary electric machine as set forth in claim 18, wherein
the refrigerant discharging section has an outlet through which the refrigerant having passed through the refrigerant flow passage is discharged, and
the outlet opens toward an end part of a coil provided on the stator core.
